(19) United States
(12) Patent Application Publication
(10) Pub. No.: US 2006/0232663 A1
(43) Pub. Date: Oct. 19, 2006

(54) SYSTEMS AND METHODS FOR A MULTIMEDIA COMMUNICATIONS SYSTEM

(75) Inventors: Darius A. Gandhi, Los Angeles, CA (US); Homi Bodhanwala, San Dimas, CA (US)

Correspondence Address: BAKER & MCKENZIE LLP;PATENT DEPARTMENT, 2001 ROSS AVENUE, SUITE 2300, DALLAS, TX, 75201, US

(73) Assignee: Any Corner LLC, Santa Monica, CA (US)

(21) Appl. No.: 11/279,840

(22) Filed: Apr. 14, 2006

Related U.S. Application Data
(60) Provisional application No. 60/671,319, filed on Apr. 14, 2005.

(51) Int. Cl. H04N 7/14

(52) U.S. Cl. 348/14.02

(57) ABSTRACT

A Multimedia Messaging Services system enables multimedia communication using handheld devices. For example, a handheld device comprising a barcode scanner can be configured to provide various multimedia communication capabilities such as two-way real-time audio, email, text messaging, image and video messaging, and so forth, which can be provided over a non-cellular data network. A development platform can enable the development of software applications for multimedia communications across various handheld device types using a device agnostic programming interface.

### CROSS-REFERENCE TO RELATED APPLICATION

This application claims the benefit of U.S. Provisional Application Ser. No. 60/671,319, filed Apr. 14, 2005, pursuant to 35 U.S.C. § 119(e), which application is hereby incorporated by reference.

### BACKGROUND OF THE INVENTION

1. Field of the Invention

The present invention generally relates to systems and methods for multimedia communications, and in particular certain embodiments of the present invention relate to systems and methods for multimedia communications over a multi-function handheld device.

2. Description of the Prior Art

Multimedia communication over handheld devices has become widespread. Because of a lack of convergence, most handheld devices are specialized to a limited number of functions or capabilities, such that the full capabilities of handheld devices generally are spread between different types of devices.

This creates the problem that for a mobile user to add communications capabilities or other special-purpose technical capabilities may require carrying and using additional handheld devices. For example, the capabilities of scanning a barcode, making a telephone call, and sending an email could require a mobile user to carry as many as three separate devices, such as a special-purpose barcode scanner, a cellular phone, and a wireless email device such as a Blackberry. This is inconvenient both from an administrative perspective, as each such device might be associated with a different carrier or network provider with separate billing, and from a physical perspective, as the mobile user is forced to carry around multiple devices. The use of different, multiple handheld devices also limits the interoperability of the various functions of those devices.

The implementation of communication and other functions on handheld devices is limited by hardware vendors' and/or network carriers' proprietary interfaces for accessing such capabilities. The number and non-uniformity of such proprietary interfaces can make it impractical to develop multimedia communication software for handheld devices, especially for software intended to run in an environment of multiple, heterogeneous handheld devices, even more so if those devices are made by different manufacturers.

### SUMMARY OF THE INVENTION

A Multimedia Messaging Services (MMS) system enables multimedia communication using handheld and stationary devices. Handheld devices can include any form of hardware or software, including any version of Windows CE, Pocket PC, Windows Mobile, Windows Embedded, Symbian, or other mobile device operating system or hardware interface. Stationary devices can include any form of hardware or software, including any version of Windows 95/98/2000/XP, Mac OS, Linux/Unix, or other operating system or hardware interface.

The MMS system can comprise a plurality of handheld devices configured to communicate with each other in various forms of multimedia, using an MMS server. The MMS Server can comprise a Session Manager to maintain session data and enforce policies, a Media Distribution Center to distribute static messages to users, a Streaming Media Engine to distribute and route live media between users, a System Database to store server configuration and session settings, a Media Store to store all messages and optionally all recorded calls passing through the MMS server, and an Inter-Server Communication Manager for connecting users across multiple MMS Servers via server-to-server communications. The system can be configured to support presence-aware devices, and to record the presence information of the devices within an MMS network, whether connected or not.

A handheld device can be configured to provide various multimedia communication capabilities such as one-way (half-duplex) or two-way (full-duplex) real-time audio or video, email, text messaging, image and video messaging, scribble messaging (capturing freeform sketches and/or handwritten text from the device's screen), and so forth, which can be provided over a data network. Communications between users can include static messages and real-time interactive calls. Handheld devices can be further integrated with special-purpose capabilities such as a barcode scanner.

Multimedia communications between devices can be propagated using data networks or cellular networks. The MMS system can be configured to integrate with cellular or landline phone networks, for network access outside a local area network, or to place outgoing calls to specific conventional phone numbers. Handheld devices can be configured to provide conventional wired and wireless telephony features such as caller ID, call waiting, voice conferencing, push-to-talk, and so forth.

A development platform comprising development modules, production modules, and a server can enable the development of software applications for multimedia communications across various handheld device types using a device agnostic programming interface. The MMS system can be configured to support integration with other software applications, including intelligent software agents.

### BRIEF DESCRIPTION OF THE DRAWINGS

FIG. 1 illustrates an MMS system comprising two MMS servers operating in lock-down mode according to certain embodiments of the present invention;

FIG. 2 illustrates an MMS system comprising a single MMS server operating in open mode according to certain embodiments of the present invention;

FIG. 3 illustrates an MMS system according to certain embodiments of the present invention

FIG. 4 illustrates a message-based conversation between two users according to certain embodiments of the present invention;

FIG. 5 illustrates a message-based conversation between four users including a broadcast message according to certain embodiments of the present invention; and

FIG. 6 illustrates a call-based conversation between five users according to certain embodiments of the present invention.

### DETAILED DESCRIPTION

The Media Messaging Services (MMS) system described herein defines a system architecture and technical specification for a communications platform, including the exchange and distribution of different forms of media and information through the interconnection of mobile and stationary users on anywhere from a local to a global scale. A “communications platform” as used herein includes any mechanism used to connect two or more users to exchange media or information. “Media” as used herein includes any binary or textual data, including text, images, audio, video, full- or half-duplex streaming media, and so forth. Mobile users can include any person, entity, or program using a mobile device such as a personal digital assistant (PDA), handheld computer, cellular phone, smart phone, barcode scanner, etc. “Barcode scanner” can include a one-dimensional barcode scanner, two-dimensional barcode scanner, or any other type of barcode scanner. Stationary users can include any person, entity, or program using a device that has network access but is either not mobile or is mobile but does not regularly move, including but not limited to traditional personal computers, dumb terminals, and mainframes. Users and services are not bound by geographic boundaries.

The Media Messaging Services described herein are not specific to any particular hardware or software platforms. For example, an MMS handheld client 316 or mobile device can be based on any type of hardware or software platform, including but not limited to Pocket PC, Windows CE, and Symbian. Likewise, an MMS desktop client 314 or stationary device can be based on any type of hardware or software platform, including but not limited to Windows 95/98/2000/XP, Mac OS, or Unix/Linux operating systems.

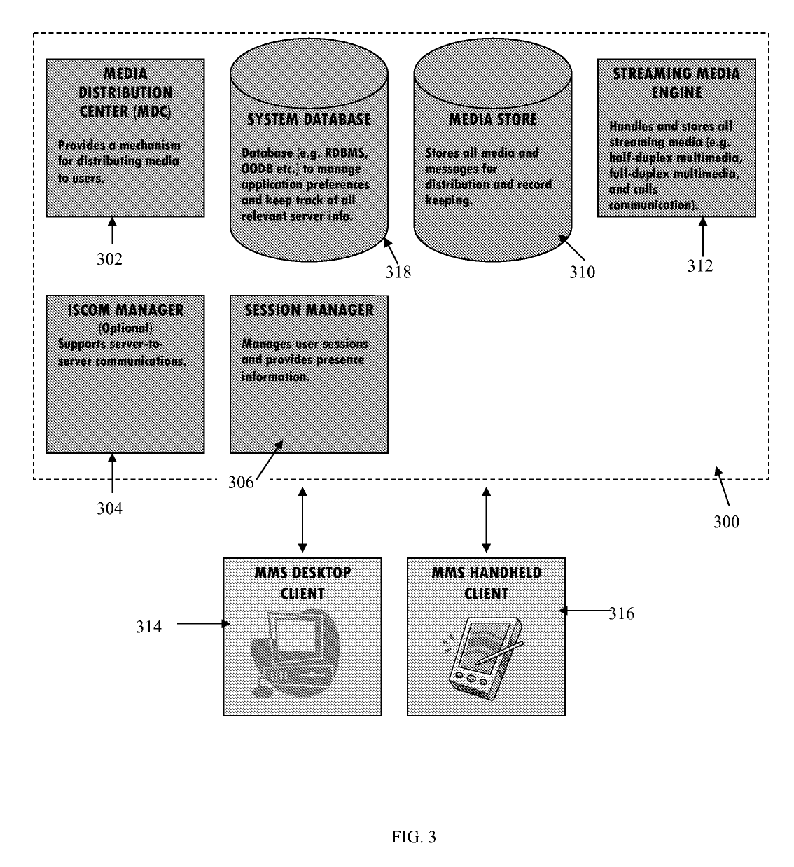

FIG. 3 illustrates the system components of an extensible architecture for an MMS Server 300, in accordance with certain embodiments. A particular MMS Server 300 implementation can include some or all of the components illustrated, further subdivide these components, or add other components.

MMS Server 300 comprises a Media Distribution Center (MDC) 302 to facilitate the exchange of media and information between users. MDC 302 can be configured to distribute data to and between MMS client applications. MDC 302 is an abstract component that can be implemented in a number of different ways. For example, MDC 302 is protocol independent, such that its data transfer functions can be implemented using any data transfer protocol such as FTP, HTTP, or a custom protocol, provided the data transfer components of corresponding MMS client applications have compatible implementations.

MMS Server 300 can further comprise a System Database 318 configured to store MMS application data. For example, System Database 318 can store information regarding the media capabilities of the devices 316 connected to the MMS Server 300, such as if a particular device has text capabilities but no voice capabilities. For another example, System Database 318 can store session data such as presence information for the users or devices connected to the MMS Server 300. For another example, System Database 318 can store call data such as the participants, devices, and media type of a call between two users, which can be used to route data packets corresponding to that call. System Database 318 can be implemented in a number of ways, including but not limited to a relational database management system (RDBMS) or an object-oriented database (OODB).

MMS Server 300 can further comprise a Media Store 310, which can store all media that passes through MMS Server 300. Media Store 310 can be configured to supply the required storage in the event MMS Server 300 is configured to maintain a persistent record of all messages and/or all calls between users, as further described below. MDC 302 can be configured to retrieve media stored in Media Store 310 and deliver it to a recipient.

Media Store 310 is an abstract component that can be implemented in a number of different ways. While System Database 318 stores application data such as session data, Media Store 310 stores information and media exchanges between clients such as email messages. Therefore, Media Store 310 can be similar to or integrated with System Database 318, depending on the embodiment.

MMS Server 300 can further comprise a Streaming Media Engine 312 configured to stream live media to MMS client devices 314, 316. While media in the form of (static) messages can be stored in Media Store 310 prior to delivery by MMS Server 300, media in the form of (dynamic) real-time calls must be streamed from the sender to the recipient because the real-time nature of calls requires delivery in increments as the media is created by the sender. For example, a prerecorded voice message can be stored in Media Store 310 and then delivered to a recipient, but a live voice call must be streamed between the sender and recipient by Streaming Media Engine 312. Streaming Media Engine 312 can facilitate the streaming of real-time media between a sender and one or more recipients in different ways. According to certain embodiments of the present invention, real-time media data is sent directly between MMS client devices 314, 316 without going through the MMS server 300, in which case the Streaming Media Engine 312 facilitates the initial connection between the MMS client devices 314, 316. According to other embodiments of the present invention, real-time media data is sent through the MMS server 300, in which case the Streaming Media Engine 312 receives and routes the real-time media packets to their destination MMS client device 314, 316. For example, Streaming Media Engine 312 can be configured to coordinate call routing between MMS users 314, 316.

MMS Server 300 can further comprise a Session Manager 306 configured to maintain session data such as presence information and the hardware capabilities of various MMS client devices 314, 316. For example, Session Manager 306 can be configured to implement authentication of client applications or client devices 314, 316 in the MMS Server 300. For another example, Session Manager 306 can be configured to enforce data bandwidth restrictions for MMS users, such as how much data is allowed to be pushed and/or pulled in a certain period of time. For another example, Session Manager 306 can be configured to automatically terminate an authenticated MMS client session after a timeout period.

The Session Manager 306 can be further configured to enforce access rights and usage policies for the MMS system. For example, the MMS system can be configured to control or “lock-down” the set of users that have access to the system and which services said users have access to. For example, the system can be configured such that only users who have been affirmatively granted access can connect to the system. Alternatively, the Media Messaging Services can be configured in “open mode,” in which any user is allowed to register with the system and interact with other users using any service. Alternatively, the system can be configured in a combination of lockdown mode and open mode.

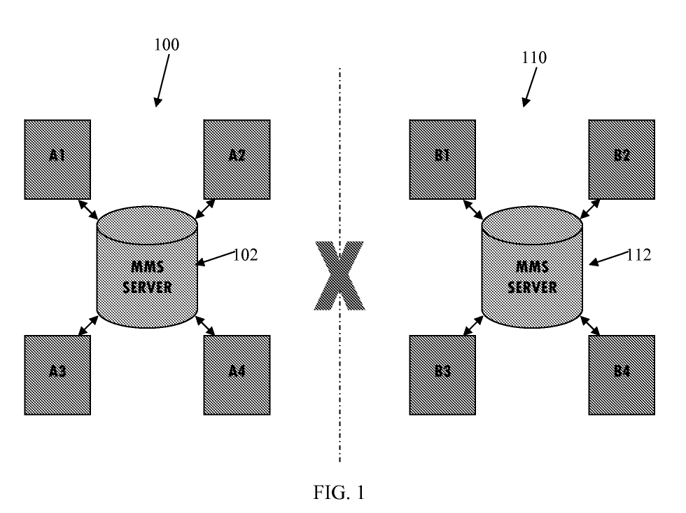

FIG. 1 is a diagram illustrating lock-down mode. In the example of FIG. 1, two MMS systems 100 and 110 are illustrated side by side. Each system comprises an MMS server, 102 and 112, respectively. Users A1-A4 have been locked down by server 102 and users B1-B4 have been locked down by server 112. Therefore, users A1-A4 cannot access server 112 and users B1-B4 cannot access server 102.

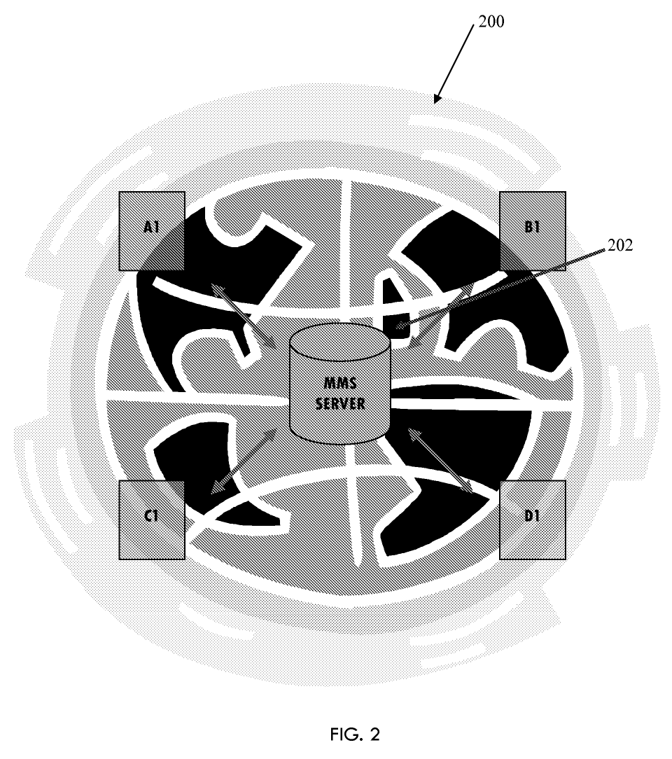

FIG. 2 is a diagram illustrating a MMS 200 comprising a MMS server 202 configured to operate in open mode. Thus, any user, e.g., A1, B1, C1, and D1 can register with, and access the server 202.

Services and/or users can be locked down at any level of granularity. For example, each type of communication service can be locked down on a service basis. For another example, a particular MMS system could have open email services but locked down voice services, such as where users can only make voice calls within the same network but can send email to any user inside or outside the local MMS network. Alternatively, an MMS server can lock down capabilities based on a combination of user constraints and services constraints, for example allowing a first user to make voice calls but not a second user.

MMS Server 300 can further comprise an Inter-Server Communication Manager (ISCOM) 304 configured to interconnect one MMS Server 300 to another MMS Server 300. ISCOM 304 can be configured to create a network of MMS Servers 300, allowing MMS devices 314, 316 on different MMS Servers 300 to communicate with each other using the same applications and interfaces used to communicate between MMS devices 314, 316 of a single MMS Server 300.

ISCOM 304 can be configured to allow a first MMS Server 300 to communication with another MMS Server 300, thereby facilitating information and media exchange among users on disparate systems. For example, an MMS user on a first MMS Server 300 can communicate via ISCOM 304, through messages or calls, with MMS users on a second MMS Server 300. Such inter-server communication can be transparent and appear to users as if the users of both servers are logged into the same server. Configuration of ISCOM 304 can require MMS Servers 300 to communicate with each other and can require additional configuration.

ISCOM 304 can be further configured to address access rights and lock-down of features on a per-server basis. For example, ISCOM 304 of a first MMS Server 300 can be configured to block certain features for users of a second MMS Server 300. For another example, ISCOM 304 can be configured to apply certain permissions and access rights for interconnected MMS Servers 3000 based on different server group policies.

The term “message” is intended to refer to any form of communication between a sender and a recipient that contains static content, meaning the entire contents of the message are known at the time of sending. In certain embodiments the sender initiates a request to pass a message to the recipient. In such embodiments, the message is automatically routed to the recipient. If a recipient does not want to receive a message from a particular sender, a restriction can be assigned on the server. Otherwise, in all instances, the only way a recipient can refuse to acknowledge a message from the sender is by not opening it. In many implementations, however, the message would still be considered delivered even if it was unopened.

A message can contain any type of media, including any binary or textual data, which can be stored in the optional body, subject, or attachment of the message. The overall size of the message, and of its individual components (e.g. body, subject, attachment), can either be fixed at a maximum value or variable. Any mechanism or protocol can be used to deliver messages from the sender to the recipient. The mechanism or protocol used will depend on the particular implementation.

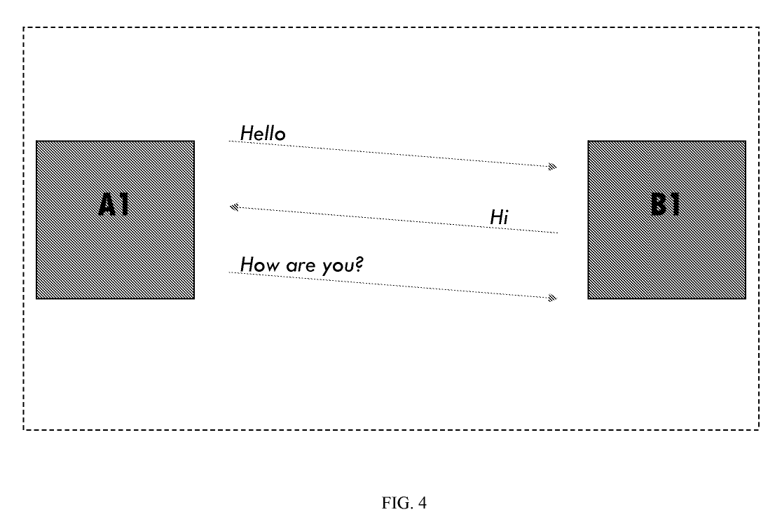

Message-based communication can be used to conduct conversations. An n-way conversation, meaning a conversation connecting n users, can be conducted as a series of one-way message exchanges. FIG. 4 illustrates a 2-way conversation (between two users). In certain embodiments, the 2-way conversation depicted in FIG. 4 can be a full-duplex 2-way communication. Further, devices A1 and B1 can comprise push-to-talk functionality for voice communication. Arguably, in certain embodiments, the push-to-talk communication can be full-duplex communication.

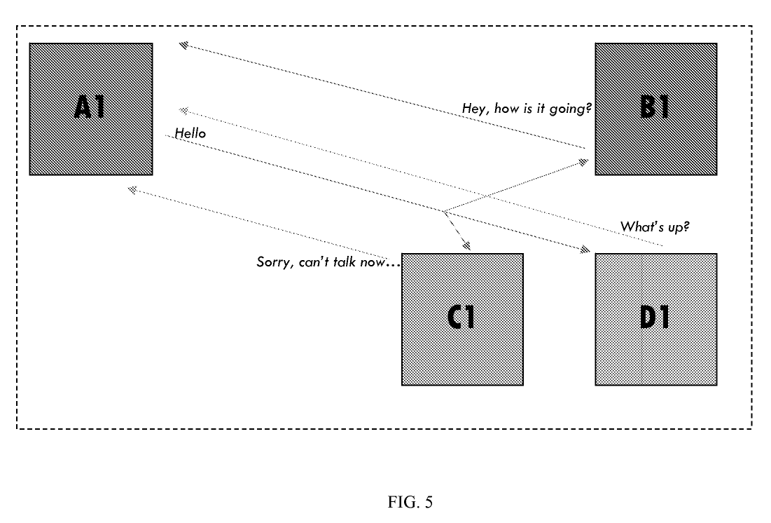

Messages can also be broadcast from a single sender to multiple recipients. This can be implemented as several one-way message exchanges from the sender to each recipient. FIG. 5 illustrates a message broadcast. As shown in FIG. 5, user A1 sends the same message to users B1, C1, and D1 via a single broadcast message “Hello.” Users B1, C1, and D1 then respond individually to user A1 via unicast (single-recipient) messages.

In general, “call” refers to another abstract form of communication that can comprise real-time, full-duplex communication between the participants. According to certain embodiments, a sender can request to initiate a call with one or more recipients. A call can comprise any type of dynamic multimedia data including text, audio, and video. Numerous mechanisms or protocols can be used to initiate a call, depending on the specific implementation. According to certain embodiments of the present invention, the MMS Server 300 can be configured to record and store all calls in the Media Store 310. Unlike a message, calls must be requested by a sender and accepted by the recipient(s). Upon receiving a call request, the recipient can choose to accept or reject the call.

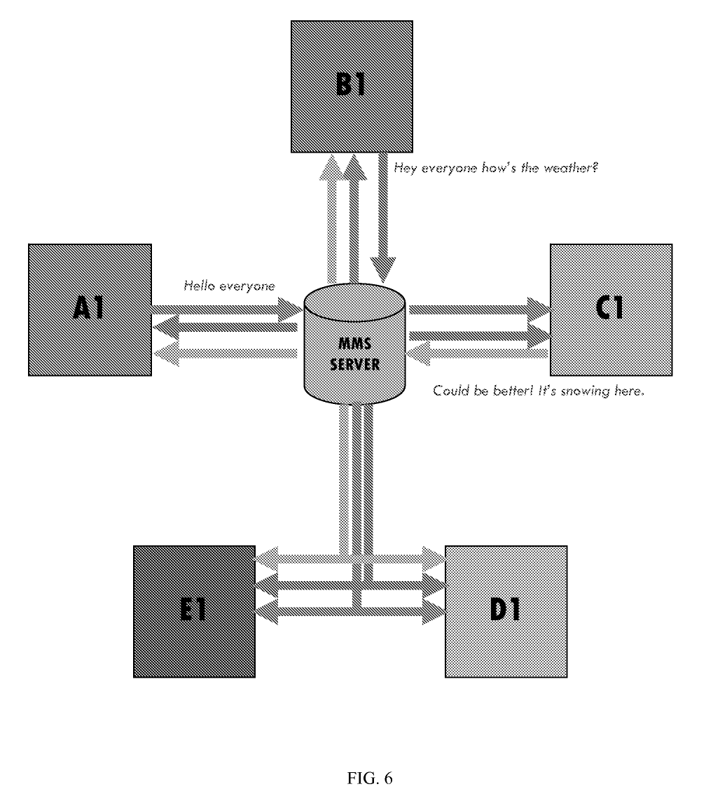

Calls can further be used for communication between more than two users at the same time (n-way). Whereas n-way conversations based on messages can consist of multiple one-way exchanges, n-way conversations based on calls can consist of full-duplex communication. FIG. 6 illustrates an n-way call between five users, A1 through E1. FIG. 6 illustrates that in a call each communication is communicated to all of the other users participating in the call (effectively broadcast).

Messages can be persistent forms of communication, meaning that as a message is sent to the recipient it is also stored in the Media Store 310 and can be retrieved any time thereafter. In the event that a message is sent to a recipient who is not online at the time, the message is available to the user when the user later logs into the system. Calls can also be persistent forms of communication, meaning that the entire conversation can be stored in the Media Store 310. Alternatively, the MMS Server 300 can be configured not to store calls, in which case call persistence, or call recording, need not be implemented.

An MMS system can be configured to support presence-aware clients. Presence information can comprise the online state of a user, including but not limited to “Online” (e.g., the user's client device is connected to the current MMS network), “Offline” (e.g., the user's client device is not connected to the current MMS network), “Do Not Disturb” (e.g., the user's client device is connected to the MMS network but the user has set the device to automatically reject incoming call requests), or “Busy” (e.g., the user is online, currently in a call, and has call waiting disabled). The current status of each user can be available to any other user who is logged into the MMS server 300, in some cases only if the user has been granted access to receive presence information. For example, groups of users can be defined and the MMS system can be configured to provide presence information only to other users in the same group. A user's presence status can be manually set by the human user, or automatically determined by the MMS server or by the user's MMS client device. For example, the user can set the status of her device to “Do Not Disturb,” which can cause the MMS server 300 or MMS client device 314, 316 to automatically reject any incoming calls.

Presence information can be implemented in a number of ways. For example, presence information can be implemented as broadcast messages from each user as that user's presence status changes. For example, presence information can be implemented using an “announcement” paradigm in which users log into the system and then announce that they are available to chat. This presence announcement can be propagated to all online clients. This same mechanism can be used whenever the online status of a client changes. Alternatively, presence information can be implemented as a query mechanism, in which a first user wanting to know the presence status of a second user would query the server for the second user's presence status.

An MMS as described herein can be configured to support “intelligent agents” as clients, meaning that users need not be humans. Intelligent agent software can be written to add additional features to a core MMS implementation, as long as the agents adhere to the client specification. For example, an email intelligent agent residing on a first MMS client could be configured to provide integrated email support by checking incoming email and forwarding urgent emails to a second MMS client as MMS messages.

An MMS system as described herein can be divided architecturally into two major components, the MMS Server 300 and MMS clients 314, 316. “Client” is used interchangeably to refer to a mobile or stationary hardware device, or MMS client application software running on such a device.

MMS clients 314, 316 can be configured to focus primarily on creating connections between two or more users to engage in information and media exchange. Communication can be conducted either through messages or through calls. MMS clients 314, 316 can be configured to provide message and call communication capabilities. MMS clients 314, 316 can be further configured to require users to log in to an MMS Server 300 for authentication. MMS clients 314, 316 can be further configured to receive, detect, and/or provide user presence information to an MMS server 300 or other MMS clients 314, 316.

The MMS Server 300 deals primarily with creating and administering connections among users. Accordingly, and as described in more detail above, the MMS Server 300 can comprise a Session Manager 306 to maintain session data (such as presence information and hardware capabilities of each device) and enforce policies (such as bandwidth restrictions), a Media Distribution Center 302 to distribute static information and data to users, a Streaming Media Engine 312 to distribute live media between users, a System Database 318 to store server configuration and session settings, a Media Store 310 to store all messages and optionally all recorded calls passing through the server 300, and an Inter-Server Communication Manager 304 for connecting users across multiple MMS Servers 300 via server-to-server communications.

This section describes one particular complete implementation of an MMS system configured in accordance with the systems and methods described herein. This implementation is referred to as “HipVoice.” Additional features can be added to the full working version of the abstract MMS communications framework. HipVoice can be implemented as an abstract software layer or middleware, which allows software developers to build applications on top of MMS services in a hardware- and platform-independent, or “device agnostic,” manner. For example, the MMS system can be provided as an MMS server 300 plus middleware software layers for all corresponding MMS client devices 314, 316, which can allow software developers to access the MMS functionality through an abstract hardware-independent software interface.

According to certain embodiments of the present invention, HipVoice emphasizes images, video, audio, scribbles, and text as its primary forms of media communication. HipVoice clients can connect and exchange text messages (which may be linked to email), images (as independent messages or attachments to other messages), video (as messages or attachments to messages), scribbles, and audio (as messages or attachments to messages). HipVoice can further be configured to provide functionality for full-duplex voice calls, or half-duplex or full-duplex push-to-talk capabilities, to any user with a unique IP address.

The MMS system can propagate communications using the Internet and several wireless WLAN providers, including T-Mobile, Sprint, Verizon and others. The MMS system can be integrated with cellular or landline phone networks to place outgoing calls to specific phone numbers. Accordingly, the MMS clients 314, 316 can be configured to provide multimedia communications over a cellular network and/or over a data network. Herein, “data network” is used to refer to networks other than the data capabilities offered by commercial cellular networks. Examples of cellular networks (some of which provide data capabilities but are not “data networks” as used herein) include networks offered by cellular carriers such as T-Mobile, Sprint, Verizon, Nextel or others, that use protocols such as GSM, GPRS, CDMA, EVDO, Edge and so forth. Examples of data networks include the Internet, local area networks that use protocols such as 802.3 (Ethernet) and/or 802.11 (WLAN), and so forth. For example, according to certain embodiments of the present invention, an MMS handheld client 316 can be configured to provide services such as voice communications, email, instant messaging and so forth over a (non-cellular) data network, without requiring access to or enrollment with a cellular carrier.

According to certain embodiments of the present invention, the MMS client devices can be configured to provide “push-to-talk” or “walkie-talkie” capabilities, in which a first user can initiate voice communications with a second user simply by pushing a button. The “button” in this case can be a physical button on the keyboard or in any other location on the handheld device, or a virtual button accessed by touching the device's screen. The push-to-talk capability can further be full-duplex, such that two users can hold down their respective push-to-talk buttons and continuously communicate with each other in real-time and at the same time.

According to certain embodiments of the present invention, the MMS server 300 can be configured to provide store-and-forward capabilities. Accordingly, if a first user sends a message to a second user who is not currently connected, the message is stored in the MDC 302 of the MMS server 300 until the second user connects. When the second user connects to the MMS server 300, the message is then delivered.

For example, if two MMS handheld clients 316 are configured to provide voice capabilities, the first MMS handheld client 316 can record an audio message and send it to the second MMS handheld client 316. The MMS server 300 can store the message until the second MMS handheld client 316 is connected. When the second MMS handheld client 316 connects to the MMS server 300, the MMS server 300 can deliver the stored audio message.

For another example, the MMS handheld clients 316 can be configured to broadcast messages to more than one other MMS handheld client 316 at the same time, and can be further configured to automatically play certain types of audio messages upon receipt. Accordingly, if a first MMS handheld client 316 broadcasts an audio message to a second MMS handheld client 316 and a third MMS handheld client 316 that are connected to the MMS server 300, the MMS server 300 will immediately deliver the audio message to the second and third MMS handheld clients 316 and the second and third MMS handheld clients 316 will automatically play the audio message. The MMS server 300 and MDC 302 can be configured to automatically store the audio message as it is sent by the first MMS handheld client 316. For another example, if the same audio message is also sent to a fourth MMS handheld client 316 who is not currently connected, then the MMS server 300 can deliver the stored audio message when the fourth MMS handheld client 316 connects to the MMS server 300, at which point the fourth MMS handheld client 316 can automatically play the audio message.

The HipVoice architecture can support and interface with numerous media communications frameworks and standards, including IMAP and POP3 email clients, SMS text messaging, Instant Messenger protocols (AIM, Yahoo, etc.), contacts and calendar items from productivity applications such as Microsoft Outlook, and various image- and video-messaging standards for cellular phones. The HipVoice architecture can also support and interface with other frameworks and standards common to various types of handheld devices or networked communications, including but not limited to GPS location services, barcode scanning capabilities, Active Directory and LDAP.

The HipVoice MMS Server 300 can support all the MMS features of the HipVoice client by, for example, running in mixed mode. Message communications can be restricted through a lock-down mode protocol, while call communications can run in open mode. A web-based tool can allow a system administrator to set system parameters, manage users, monitor and manage messages, and manage sessions. Active Directory and LDAP integration can be supported for easy migration of user accounts.

According to certain implementations, HipVoice can integrate multiple handheld appliances into a single multi-function handheld unit. For example, for implementations that emphasize voice-based technologies for mobile users, several voice-related technologies can be incorporated or integrated into the MMS client handheld device 316, including not limited to dialing to external voice phone numbers, importing SIM data from other mobile devices, n-way voice conferencing, speed dial, call history, caller ID, caller ID blocking, call holding, call waiting. For another example, HipVoice implementations emphasizing mobile users can provide an interface for disabling the mobile antenna when necessary such as when flying on an airplane.

In addition to providing the necessary MMS Server 300 implementation, the HipVoice server can be extended as needed to support all the requirements of a particular HipVoice Client implementation or MMS client hardware 314, 316. For example, an MMS mobile device can include an integrated barcode scanner, and the corresponding MMS server can be extended to provide integrated barcode features such as integration with an inventory management system.

For another example, an MMS mobile device 416 can be configured to make calls within the MMS network, meaning calls to users connected to the same MMS Server 300 or to an interconnected MMS Server 300, using VOIP and to make calls outside the MMS network using a cellular communications network.

In cases where an MMS system is configured to connect to multiple networks having varying characteristics such as signal strength and cost per unit of data, the MMS system can be configured to route outgoing calls based on predefined preferences. For example, a user could define a call routing scheme of “least expensive network first,” in which case the MMS system could automatically connect to the lowest cost network available at the time of the call. Alternatively, the system administrator could define a call routing scheme of “best signal strength first, least expensive network second,” in which case the MMS system could automatically connect to the network with the best signal strength at the time of the call and, if there were more than one network with equally good signal strength, then to the least expensive (e.g., in terms of cost per minute) of those networks.

The MMS system can be further configured to transparently switch between multiple available networks as more preferred networks become available. For example, when a user is away from a work location the MMS client device 316 can be configured to connect via the cheapest cellular network available, then, when the user returns to a work location, transparently switch its connection to the local area network of the MMS server 300 (e.g., an 802.11 network).

According to certain embodiments of the present invention, the MMS system and HipVoice in particular can be configured to integrate with other applications on a particular handheld device as well a integrate with applications already on the system.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed is:

1. A handheld multimedia communications system, comprising:
a first handheld device comprising a barcode scanner; and
a second handheld device, wherein the first and second handheld devices are configured to provide real-time voice communication between them.

2. A handheld multimedia communications system of claim 1, wherein the first and second handheld devices are configured to provide push-to-talk capabilities.

3. A handheld multimedia communications system of claim 1, further comprising:
a server configured to receive a first multimedia message from the second handheld device, store the first multimedia message, and, when the first handheld device connects to the server or immediately if the first handheld is already connected to the server, deliver the first multimedia message to the first handheld device.

4. A handheld multimedia communications system of claim 3, wherein the first multimedia message is an audio message, and wherein the first handheld device is further configured to automatically play the first multimedia message upon delivery.

5. A handheld multimedia communications system, comprising:
a first handheld device comprising the Windows CE operating system; and
a second handheld device, wherein the first and second handheld devices are configured to provide real-time voice communication between them.

6. A handheld multimedia communications system of claim 5, wherein the second handheld device comprises the Windows CE operating system.

7. A handheld multimedia communications system of claim 5, wherein the second handheld device comprises the Pocket PC operating system.

8. A handheld multimedia communications system of claim 5, wherein the second handheld device comprises the Symbian operating system.

9. A handheld multimedia communications device, comprising:
a barcode scanner;
an image capture component configured to capture a first image;
an image markup component configured to modify the first image; and
a network component configured to transmit the modified first image.

10. A handheld communications device, comprising:
a barcode scanner; and
a voice communications component configured to provide half-duplex voice communications.

11. A handheld communications device of claim 10, wherein the voice communications component is further configured to provide push-to-talk capabilities.

12. A handheld communications device of claim 10, further comprising:
an electronic mail component configured to provide electronic mail capabilities.

13. A handheld communications device of claim 10, wherein the voice communications component is further configured to provide full-duplex voice communications.

14. A handheld communications device of claim 13, wherein the voice communications component is further configured to provide push-to-talk capabilities.

15. A handheld communications device of claim 13, further comprising:
an image capture component configured to capture a first image;
an image markup component configured to modify the first image, and
wherein the electronic mail component is further configured to transmit the modified first image.

16. A handheld communications device of claim 13, further comprising:
an electronic mail component configured to provide electronic mail capabilities.

17. A handheld communications device of claim 16, further comprising:
an instant messaging component configured to provide instant messaging capabilities.

18. A handheld communications device, comprising:
a voice communications component configured to provide half-duplex voice communications over a data network.

19. A handheld communications device of claim 18, wherein the voice communications component is further configured to provide push-to-talk capabilities over a data network.

20. A handheld communications device of claim 18, further comprising:
an electronic mail component configured to provide electronic mail capabilities over a data network.

21. A handheld communications device of claim 18, wherein the voice communications component is further configured to provide full-duplex voice communications over a data network.

22. A handheld communications device of claim 21, wherein the voice communications component is further configured to provide push-to-talk capabilities over a data network.

23. A handheld communications device of claim 21, further comprising:
an electronic mail component configured to provide electronic mail capabilities over a data network.

24. A multimedia communications server, comprising:
a media distribution center configured to distribute static media sent between a first user connected to the server and a second user connected to the server;
a media store configured to store the static media sent between the first user and the second user;
a streaming media engine configured to deliver live media sent between the first user and the second user;
a session manager configured to maintain session data relating to the interconnection of the first user and the second user; and
a system database configured to store the session data.

25. A multimedia communications server of claim 24, further comprising:
an inter-server communication manager configured to interconnect the server with a second multimedia communications server and allow the first user to communicate with a third user connected to the second server.

26. A method for multimedia communications over handheld devices, comprising:
transmitting and receiving real-time voice communications between a first handheld device and a second handheld device, wherein the first handheld device comprises a barcode scanner.

27. A multimedia communications development platform configured to assist in the development of mobile device applications that are device agnostic, comprising:
development modules configured to enable the development of device agnostic applications that are compatible with any of a plurality of mobile device types;
production modules for each of the plurality of mobile device types configured to enable multimedia communications between the plurality of mobile device types for device agnostic applications developed using the development modules; and
a server configured to enable multimedia communications between the plurality of mobile device types for device agnostic applications developed using the development modules, wherein the production modules and server are further configured to interact with each other.
